(19) United States
(12) Patent Application Publication
(10) Pub. No.: US 2013/0231025 A1
(43) Pub. Date: Sep. 5, 2013

(54) METHOD AND DEVICE FOR MANUFACTURING LIQUID CRYSTAL PANEL

(71) Applicant: Cheng-hung Chen, Shenzhen (CN)

(72) Inventor: Cheng-hung Chen, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/510,330

(22) PCT Filed: Mar. 13, 2012
(86) PCT No.: PCT/CN2012/072225

§ 371 Date: May 17, 2012

(30) Foreign Application Priority Data
Mar. 2, 2012 (CN) 201210054825.2

(51) Int. Cl. H01J 9/50

(52) U.S. Cl. 445/2; 445/61

(57) ABSTRACT

The present invention discloses a method and a device for manufacturing liquid crystal panel. The method includes: after introducing liquid crystal between two substrates, subjecting the substrates to edge cutting in order to expose a signal pad; supplying an inspection signal to the signal pad to effect inspection, wherein if a defect is found, then repair of the defect is carried out; and after the inspection or after the repair, applying first alignment to have monomers of the liquid crystal polymerized to form pre-tilt angle. The present invention carries out inspection of substrates before an alignment operation is performed to have monomers of liquid crystal polymerized to show pre-tilt angle and if no defect is identified or if defects are identified but are subjected to repairing by a repair process to ensure that no defect exists in the substrates, the liquid crystal monomers are processed to show the pre-tilt angle.

### BACKGROUND OF THE INVENTION

1. Field of the Invention

The present invention relates to the field of liquid crystal displaying techniques, and in particular to a method and a device for manufacturing liquid crystal panel.

2. The Related Arts

In the known techniques, the manufacture of liquid crystal panel, especially PSVA (Polymer Stabilized Vertical Alignment) liquid crystal panel is generally done with a process that comprises:

(1) After ODF (One Drop Filling), performing edge cutting of a substrate;

(2) applying heating or UV (Ultra Violet) irradiation to polymerize liquid crystal monomers at pre-tilt angle, namely the liquid crystal molecules being set in alignment;

(3) Carrying out macro inspection of the substrate, followed by chip cutting to cut the substrate into a plurality of liquid crystal panels and the carrying POL (attaching polarizer) and inspection (light-up inspection), whereby in case defects are found in the light-up inspection, a corresponding repair process is carried out to effect repair of the liquid crystal panel.

Through long-term research study, the present inventor gets aware that in normal situations, a defect of a liquid crystal panel, such as breaking of a signal line or shorting between different signal lines, was present well before the process of manufacturing the PSVA liquid crystal panel. After being subjected to heating or irradiation of UV, the defect is memorized in the liquid crystal panel in the form of pre-tilt angle and cannot be completely repaired, namely being repaired to show essentially zero power, even a repair operation is applied.

### SUMMARY OF THE INVENTION

The technical issue to be addressed by the present invention is to overcome the problem that a defect of a liquid crystal panel is memorized in the liquid crystal panel in the form of pre-tilt angle of the liquid crystal molecules and thus cannot be completely repaired by providing a method and a device for manufacturing liquid crystal panel.

To address the above technical issue, the present invention adopts a technical solution that provides a method for manufacturing liquid crystal panel, comprising: forming alignment layers on two substrates; introducing liquid crystal between the two substrates after the formation of the alignment layer, wherein the alignment layers are located on opposing surfaces of the two substrates; after introducing the liquid crystal, subjecting the substrates to edge cutting in order to expose a signal pad; supplying an inspection signal to the signal pad and placing the substrates on a light box to carry out macro inspection; determining if a defect is identified and repairing the defect if a defect is identified; applying first alignment to have monomers of the liquid crystal polymerized to form pre-tilt angle after the inspection or after the repair; after the first alignment, carrying out optic inspection on the liquid crystal to determine if any un-polymerized monomer exists in the liquid crystal; and carrying out second alignment of un-polymerized monomer without application of voltage if it is determined that un-polymerized monomer exists in the liquid crystal to have the monomer showing the pre-tilt angle.

Wherein, after the step of carrying out second alignment of un-polymerized monomer without application of voltage if it is determined that un-polymerized monomer exists in the liquid crystal to have it showing the pre-tilt angle, the method further comprises: after the second alignment, subjecting the substrates to liquid crystal panel cutting to form a plurality of liquid crystal panels; attaching polarizers to the plurality of liquid crystal panels and carrying out light-up test to further identify if any defect exists in the plurality of liquid crystal panels; and carrying out laser cutting on the plurality of liquid crystal panels after it is identified that no defect exists in the plurality of liquid crystal panels in order to cut off edge lines of the liquid crystal panel.

Wherein, after the step of attaching polarizers to the plurality of liquid crystal panels and carrying out light-up test to further identify if any defect exists in the plurality of liquid crystal panels, the method further comprises: applying corresponding repairing processes to repair the liquid crystal panel when defects of weak lines and abnormal images are identified.

Wherein, the step of applying first alignment to have monomers of the liquid crystal polymerized to form pre-tilt angle after the inspection or after the repair comprises: after the inspection or after the repair, applying heating or ultraviolet radiation to subject the liquid crystal to alignment so that the monomers of the liquid crystal are polymerized to show the pre-tilt angle.

To address the above technical issue, the present invention adopts another technical solution that provides a method for manufacturing liquid crystal panel. The method comprises: after introducing liquid crystal between two substrates, subjecting the substrates to edge cutting in order to expose a signal pad; supplying an inspection signal to the signal pad to effect inspection, wherein if a defect is found, then repair of the defect is carried out; and after the inspection or after the repair, applying first alignment to have monomers of the liquid crystal polymerized to form pre-tilt angle.

Wherein, the step of supplying an inspection signal to the signal pad to effect inspection, wherein if a defect is found, then repair of the defect is carried out comprises: supplying the inspection signal to the signal pad and placing the substrates on a light box to carry out macro inspection; and determining if a defect is identified, repairing the defect if a defect is identified, and applying the first alignment to have the monomers of the liquid crystal polymerized to show the pre-tilt angle if no defect is identified.

Wherein, after the step of applying the first alignment to have the monomers of the liquid crystal polymerized to show the pre-tilt angle after the macro inspection or after the repairing, the method further comprises: after the first alignment, carrying out optic inspection on the liquid crystal to determine if any un-polymerized monomer exists in the liquid crystal; and carrying out second alignment of un-polymerized monomer without application of voltage if it is determined that un-polymerized monomer exists in the liquid crystal to have the monomer showing the pre-tilt angle.

Wherein, after the step of carrying out second alignment of un-polymerized monomer without application of voltage if it is determined that un-polymerized monomer exists in the liquid crystal to have the monomer showing the pre-tilt angle, the method further comprises: after the second alignment, subjecting the substrates to liquid crystal panel cutting to form a plurality of liquid crystal panels; attaching polarizers to the plurality of liquid crystal panels and carrying out light-up test to further identify if any defect exists in the plurality of liquid crystal panels; and carrying out laser cutting on the plurality of liquid crystal panels after it is identified that no defect exists in the plurality of liquid crystal panels in order to cut off edge lines of the liquid crystal panel.

Wherein, after the step of attaching polarizers to the plurality of liquid crystal panels and carrying out light-up test to further identify if any defect exists in the plurality of liquid crystal panels, the method further comprises: applying corresponding repairing processes to repair the liquid crystal panel when defects of weak lines and abnormal images are identified.

Wherein, the step of applying first alignment to have monomers of the liquid crystal polymerized to form pre-tilt angle after the inspection or after the repair comprises: after the inspection or after the repair, applying heating or ultraviolet radiation to subject the liquid crystal to the first alignment so that the monomers of the liquid crystal are polymerized to show the pre-tilt angle.

Wherein, before the step of after introducing liquid crystal between two substrates, subjecting the substrates to edge cutting in order to expose a signal pad, the method further comprises: forming alignment layers on the two substrates; and introducing the liquid crystal between the two substrates after the formation of the alignment layer, wherein the alignment layers are located on opposing surfaces of the two substrates.

To address the above technical issue, the present invention adopts a further technical solution that provides a device for manufacturing liquid crystal panel, which comprises an edge cutting mechanism, an inspection mechanism, a repair mechanism, and a first alignment mechanism. The edge cutting mechanism is provided for subjecting substrates to edge cutting in order to expose a signal pad after introducing liquid crystal between two substrates. The inspection mechanism is provided for supplying an inspection signal to the signal pad to effect inspection. The repair mechanism is provided for carrying out repair of defect when the inspection mechanism identifies a defect. The first alignment mechanism is provided for applying first alignment to the substrates that have been inspected or repaired to have monomers of the liquid crystal polymerized to form pre-tilt angle.

Wherein, the device for manufacturing liquid crystal panel further comprises: an optic inspection mechanism and a second alignment mechanism. The optic inspection mechanism is provided for carrying out optic inspection on the liquid crystal after the first alignment in order to determine if any un-polymerized monomer exists in the liquid crystal. The second alignment mechanism is provided for carrying out second alignment of un-polymerized monomer without application of voltage if it is determined that un-polymerized monomer exists in the liquid crystal to have the monomer showing the pre-tilt angle.

Wherein, the device for manufacturing liquid crystal panel further comprises: a chip cutting mechanism, an attaching mechanism, a test mechanism, and a laser cutting mechanism. The chip cutting mechanism is provided for subjecting the substrates that are determined to comprise no un-polymerized monomer or comprise un-polymerized monomer that is subjected to the second alignment to liquid crystal panel cutting to form a plurality of liquid crystal panels. The attaching mechanism is provided for attaching polarizers to the plurality of liquid crystal panels. The test mechanism is provided for carrying out light-up test on the plurality of liquid crystal panels to which the polarizers are attached to further identify if any defect exists in the plurality of liquid crystal panels. The laser cutting mechanism is provided for carrying out laser cutting to cut off edge lines of the liquid crystal panels after it is identified that no defect exists in the plurality of liquid crystal panels with the light-up test.

The efficacy of the present invention is that to be distinguished from the prior art technology, the present invention provides a method for manufacturing liquid crystal panel, which carries out inspection of substrates before an alignment operation is performed to have monomers of liquid crystal polymerized to show pre-tilt angle and if no defect is identified or if defects are identified but are subjected to repairing by a repair process to ensure that no defect exists in the substrates, the liquid crystal monomers are processed to show the pre-tilt angle. Since defect inspection and repair of any identified defect, where the rate of successfully repairing the defect, are both done before alignment is made. This prevents the defects of signal line breaking or shorting among different signal lines from being long memorized in the liquid crystal panel after being subjected to alignment. The present invention effectively improves the qualification rate of manufacture of liquid crystal panel.

### BRIEF DESCRIPTION OF THE DRAWINGS

FIG. 1 is a flow chart showing a method for manufacturing liquid crystal panel according to an embodiment of the present invention;

FIG. 2 is a flow chart showing a method for manufacturing liquid crystal panel according to another embodiment of the present invention; and

FIG. 3 is a schematic view illustrating connections among components of a device for manufacturing liquid crystal panel according to an embodiment of the present invention.

### DETAILED DESCRIPTION OF THE PREFERRED EMBODIMENTS

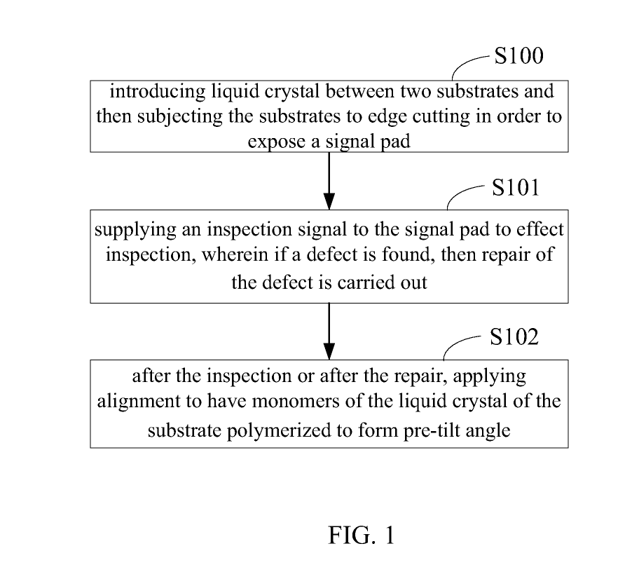

Referring to FIG. 1, a flow chart of a method for manufacturing liquid crystal panel according to an embodiment of the present invention is shown. The method for manufacturing liquid crystal panel according to the present invention is applicable to the manufacture of PSVA and MVA (Multi-domain Vertical Alignment) liquid crystal panels, but not limited thereto. Unnecessary description, which is generally within the scope that a person skilled in the art appreciates, will be omitted. In the instant embodiment, the method for manufacturing liquid crystal panel comprises the following steps:

Step S100: introducing liquid crystal between two substrates and then subjecting the substrates to edge cutting in order to expose a signal pad.

With Step S100, the signal pad that is arranged at an edge of the substrates is exposed for subsequent inspection. Certainly, before Step S100, other routing steps, including forming alignment layer on the substrates and dropping or filling liquid crystal, may be carried out.

Step S101: supplying an inspection signal to the signal pad to effect inspection, wherein if a defect is found, then repair of the defect is carried out.

If the substrates show defects of for example breaking of signal line or shorting between signal lines, then any repair performed after an alignment operation is ineffective to repair the defects. Thus, this Step S101 is arranged before alignment and inspection is carried out on the substrates in advance by supplying the inspection signal in order to have all kinds of defect repaired before alignment is performed. The inspection technique adopted in this Step S101 includes macro inspection and visual inspection carried out with a light box and corresponding adjustments may be effected according to the practical situations, such as preciseness. No limitation is imposed herein.

Step S102: after the inspection or after the repair, applying first alignment to have monomers of the liquid crystal polymerized to form pre-tilt angle.

In Step S102, concern is primarily placed on the first alignment of the substrates, before the first alignment is carried out, any identified defect is first completely repaired and then this Step S102 is carried out, so as to effectively prevent the defects from being memorized in the liquid crystal panel in the form of pre-tilt angle of the liquid crystal monomers. In other embodiments, there may be second alignment, namely Step S101 can be placed between the first alignment and the second alignment so as to handle, at least to some extents, the problems of the known techniques that complete repair is impossible due to the process of inspection and repair carried out in Step S102 being placed behind the second alignment. Further, in the instant embodiment, alignment is realized through rubbing, heating, or UV, but not limited thereto. No specific limitation is imposed here.

Besides the above steps, after Step S102, there may be further included the steps of attaching polarizer, light-up test, and re-inspection of the repair. No limitation is imposed here.

To be distinguished from the prior art technology, the present invention provides a method for manufacturing liquid crystal panel, which carries out inspection of substrates before an alignment operation is performed to have monomers of liquid crystal polymerized to show pre-tilt angle and if no defect is identified or if defects are identified but are subjected to repairing by a repair process to ensure that no defect exists in the substrates, the liquid crystal monomers are processed to show the pre-tilt angle. Since defect inspection and repair of any identified defect, where the rate of successfully repairing the defect, are both done before alignment is made. This prevents the defects of signal line breaking or shorting among different signal lines from being long memorized in the liquid crystal panel after being subjected to alignment. The present invention effectively improves the qualification rate of manufacture of liquid crystal panel.

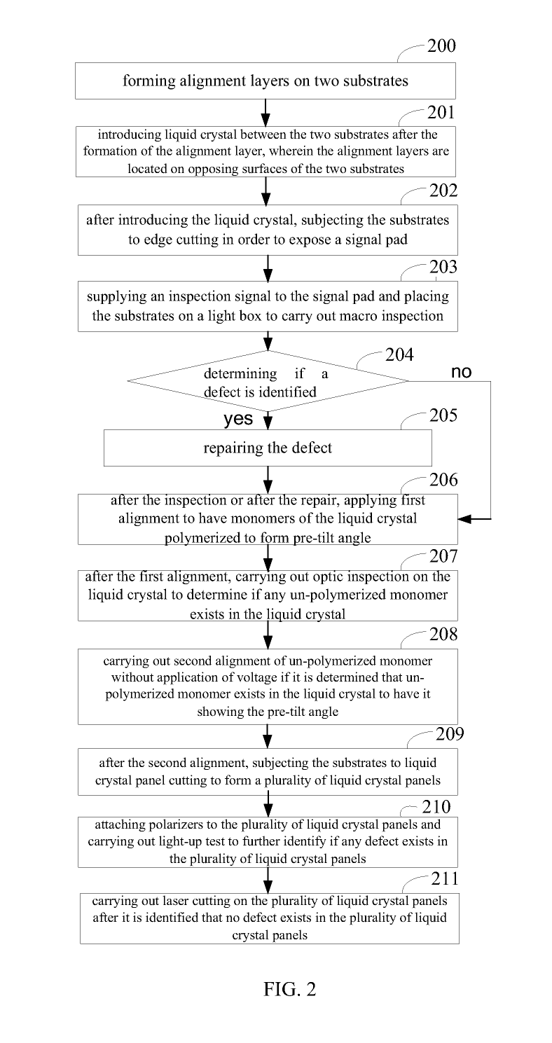

Referring to FIG. 2, a flow chart of a method for manufacturing liquid crystal panel according to another embodiment of the present invention is shown. In the instant embodiment, the method for manufacturing liquid crystal panel comprises the following steps:

Step S200: forming alignment layers on two substrates.

With Step S200, alignment layers or alignment films are formed on the substrates. The alignment layers may contain alignment material, UV absorber, photo stabilizer, and solvent. If alignment is done with heating, then the material of the alignment layer may be adjusted correspondingly. No limitation is imposed herein in this respect.

Step S201: introducing liquid crystal between the two substrates after the formation of the alignment layer, wherein the alignment layers are located on opposing surfaces of the two substrates.

The process of introducing liquid crystal that can be adopted in this Step S201 includes dropping and filling. Dropping is preferably adopted for great saving of the liquid crystal material.

Step S202: after introducing the liquid crystal, subjecting the substrates to edge cutting in order to expose a signal pad.

With Step S202, the signal pad that is arranged at an edge of the substrates is exposed. The signal pad can be singular or plural that are spaced from each other. No limitation is imposed here in this respect.

Step S203: supplying an inspection signal to the signal pad and placing the substrates on a light box to carry out macro inspection.

If the substrates show defects of for example breaking of signal line or shorting between signal lines, then any repair performed after an alignment operation is ineffective to repair the defects. Thus, this Step S203 is arranged before alignment and inspection is carried out on the substrates in advance by supplying the inspection signal in order to have all kinds of defect repaired before alignment is performed. The inspection technique adopted in this Step S203 includes macro inspection and visual inspection carried out with a light box and corresponding adjustments may be effected according to the practical situations. No limitation is imposed herein.

Step S204: determining if a defect is identified.

Generally, Step S204 can be operated through smart determination made with a system or manual determination can be made. For example, a defect is identified through visual inspection and then a determination is made in such a way that Step S205 is carried out for a positive answer, otherwise Step S206 is carried out for a negative answer.

Step S205, repairing the defect.

In Step S205, it is preferable to adopt sheet repair process to repair the substrates in order to realize effective repair of defects such as signal line breaking, shorting among signal lines, and weak line. Apparently, other process of repair can be equally adopted. No limitation is imposed herein.

Step S206: after the inspection or after the repair, applying first alignment to have monomers of the liquid crystal polymerized to form pre-tilt angle. Alignment carried out in Step S206 can be done with heating or UV.

Step S207: after the first alignment, carrying out optic inspection on the liquid crystal to determine if any un-polymerized monomer exists in the liquid crystal. If it is determined that un-polymerized monomer is present in the liquid crystal, then Step S208 is performed; if it is determined that no un-polymerized monomer exists in the liquid crystal, then Step S209 is performed. The process from Step S207 to Step S208 can be a cyclic process and the number of the cycles or the result can be manually set to meet practical needs. No limitation is imposed within the scope that a person skilled in the art may appreciate.

Step S208: carrying out second alignment of un-polymerized monomer without application of voltage if it is determined that un-polymerized monomer exists in the liquid crystal to have it showing the pre-tilt angle. Through this Step S208, the monomer of the liquid crystal that fails alignment may be subjected to alignment again to ensure the qualification rate of the liquid crystal panel.

Step S209: after the second alignment, subjecting the substrates to liquid crystal panel cutting to form a plurality of liquid crystal panels.

Step S210: attaching polarizers to the plurality of liquid crystal panels and carrying out light-up test to further identify if any defect exists in the plurality of liquid crystal panels. After Step S210, if defects, such as weak line and abnormal image, are found, it is still possible to use corresponding repairing process to perform the repairing of the liquid crystal panel.

Step S211: carrying out laser cutting on the plurality of liquid crystal panels after it is identified that no defect exists in the plurality of liquid crystal panels. Laser cutting cuts off edge lines for the purposes of breaking short bars (which are a pre-protection arrangement) of the panel so that the liquid crystal panel can be independently driven by signals.

To be distinguished from the prior art technology, the present invention provides a method for manufacturing liquid crystal panel, which carries out inspection of substrates before an alignment operation is performed to have monomers of liquid crystal polymerized to show pre-tilt angle and if no defect is identified or if defects are identified but are subjected to repairing by a repair process to ensure that no defect exists in the substrates, the liquid crystal monomers are processed to show the pre-tilt angle. Since defect inspection and repair of any identified defect, where the rate of successfully repairing the defect, are both done before alignment is made. This prevents the defects of signal line breaking or shorting among different signal lines from being long memorized in the liquid crystal panel after being subjected to alignment. The present invention effectively improves the qualification rate of manufacture of liquid crystal panel.

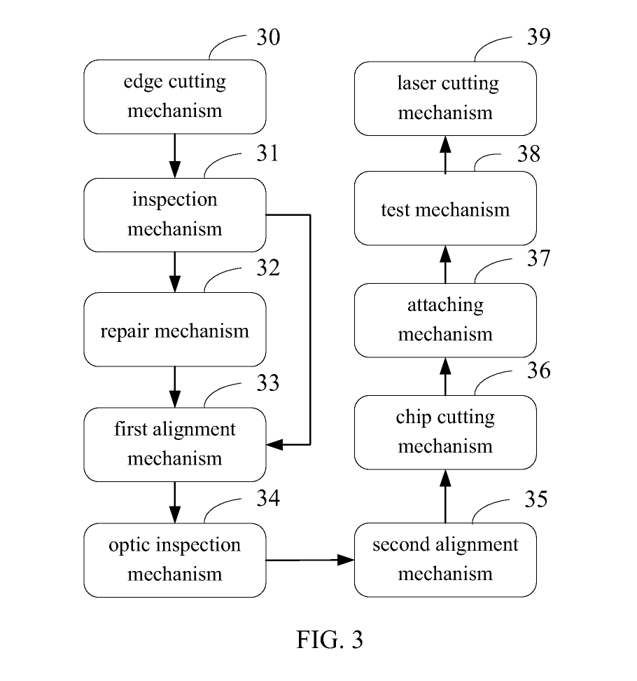

Referring to FIG. 3, a schematic view illustrating connections among components of a device for manufacturing liquid crystal panel according to an embodiment of the present invention is shown.

In the instant embodiment, the device for manufacturing liquid crystal panel comprises an edge cutting mechanism 30, an inspection mechanism 31, a repair mechanism 32, and a first alignment mechanism 33 that are connected in such a sequence. The term “connection” used here may include that a general control console separately controls the edge cutting mechanism 30, the inspection mechanism 31, the repair mechanism 32, and the first alignment mechanism 33 to realize indirect “connection”.

Also referring to the embodiment illustrated in FIG. 1, Step S100 is carried out by the edge cutting mechanism 30; Step S101 is carried out by the inspection mechanism 31 and the repair mechanism 32; and Step S102 is carried by the first alignment mechanism 33.

The device for manufacturing liquid crystal panel according to the present invention further comprises, sequentially connected, an optic inspection mechanism 34, a second alignment mechanism 35, a chip cutting mechanism 36, an attaching mechanism 37, a test mechanism 38, and a laser cutting mechanism 39, in which the first alignment mechanism 33 is connected to the optic inspection mechanism 34 and the inspection mechanism 31 is also connected to the first alignment mechanism 33. In the embodiment illustrated in FIG. 2, Step S202 is carried out by the edge cutting mechanism 30; Step S203 is carried out by the inspection mechanism 31; Step S205 is carried out by the repair mechanism 32; Step S206 is carried out by the first alignment mechanism 33; Step S207 is carried out by the optic inspection mechanism 34; Step S208 is carried out by the second alignment mechanism 35; Step S209 is carried out by the chip cutting mechanism 36; Step S210 is carried out by the attaching mechanism 37 and the test mechanism 38; and Step S211 is carried out by the laser cutting mechanism 39. The flow of operation can be referred to the operation principles of the method for manufacturing liquid crystal panel illustrated in FIG. 1 or 2. Repeated description will be omitted herein.

Further, the device for manufacturing liquid crystal panel according to the present invention further comprises an alignment layer coating mechanism that caries out Step S200 and a liquid crystal introducing mechanism that carries out Step S201. No specific limitation is imposed here.

To be distinguished from the prior art technology, the present invention provides a device for manufacturing liquid crystal panel, as well as the methods for manufacturing liquid crystal panel discussed previously, which carries out inspection of substrates before an alignment operation is performed to have monomers of liquid crystal polymerized to show pre-tilt angle and if no defect is identified or if defects are identified but are subjected to repairing by a repair process to ensure that no defect exists in the substrates, the liquid crystal monomers are processed to show the pre-tilt angle. Since defect inspection and repair of any identified defect, where the rate of successfully repairing the defect, are both done before alignment is made. This prevents the defects of signal line breaking or shorting among different signal lines from being long memorized in the liquid crystal panel after being subjected to alignment. The present invention effectively improves the qualification rate of manufacture of liquid crystal panel.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A method for manufacturing liquid crystal panel, characterized by comprising:
forming alignment layers on two substrates;
introducing liquid crystal between the two substrates after the formation of the alignment layer, wherein the alignment layers are located on opposing surfaces of the two substrates;
after introducing the liquid crystal, subjecting the substrates to edge cutting in order to expose a signal pad;
supplying an inspection signal to the signal pad and placing the substrates on a light box to carry out macro inspection;
determining if a defect is identified and repairing the defect if a defect is identified;
applying first alignment to have monomers of the liquid crystal polymerized to form pre-tilt angle after the inspection or after the repair;
after the first alignment, carrying out optic inspection on the liquid crystal to determine if any un-polymerized monomer exists in the liquid crystal; and
carrying out second alignment of un-polymerized monomer without application of voltage if it is determined that un-polymerized monomer exists in the liquid crystal to have the monomer showing the pre-tilt angle.

2. The method as claimed in claim 1, characterized in that after the step of carrying out second alignment of un-polymerized monomer without application of voltage if it is determined that un-polymerized monomer exists in the liquid crystal to have it showing the pre-tilt angle, the method further comprises the following steps:
after the second alignment, subjecting the substrates to liquid crystal panel cutting to form a plurality of liquid crystal panels;
attaching polarizers to the plurality of liquid crystal panels and carrying out light-up test to further identify if any defect exists in the plurality of liquid crystal panels; and
carrying out laser cutting on the plurality of liquid crystal panels after it is identified that no defect exists in the plurality of liquid crystal panels in order to cut off edge lines of the liquid crystal panel.

3. The method as claimed in claim 2, characterized in that after the step of attaching polarizers to the plurality of liquid crystal panels and carrying out light-up test to further identify if any defect exists in the plurality of liquid crystal panels, the method further comprises the following step:
applying corresponding repairing processes to repair the liquid crystal panel when defects of weak lines and abnormal images are identified.

4. The method as claimed in claim 1, characterized in that the step of applying first alignment to have monomers of the liquid crystal polymerized to form pre-tilt angle after the inspection or after the repair comprises the following step:
after the inspection or after the repair, applying heating or ultraviolet radiation to subject the liquid crystal to alignment so that the monomers of the liquid crystal are polymerized to show the pre-tilt angle.

5. A method for manufacturing liquid crystal panel, characterized by comprising:
after introducing liquid crystal between two substrates, subjecting the substrates to edge cutting in order to expose a signal pad;
supplying an inspection signal to the signal pad to effect inspection, wherein if a defect is found, then repair of the defect is carried out; and
after the inspection or after the repair, applying first alignment to have monomers of the liquid crystal polymerized to form pre-tilt angle.

6. The method as claimed in claim 5, characterized in that the step of supplying an inspection signal to the signal pad to effect inspection, wherein if a defect is found, then repair of the defect is carried out comprises the following steps:
supplying the inspection signal to the signal pad and placing the substrates on a light box to carry out macro inspection; and
determining if a defect is identified, repairing the defect if a defect is identified, and applying the first alignment to have the monomers of the liquid crystal polymerized to show the pre-tilt angle if no defect is identified.

7. The method as claimed in claim 6, characterized in that after the step of applying the first alignment to have the monomers of the liquid crystal polymerized to show the pre-tilt angle after the macro inspection or after the repairing, the method further comprises the following steps:
after the first alignment, carrying out optic inspection on the liquid crystal to determine if any un-polymerized monomer exists in the liquid crystal; and
carrying out second alignment of un-polymerized monomer without application of voltage if it is determined that un-polymerized monomer exists in the liquid crystal to have the monomer showing the pre-tilt angle.

8. The method as claimed in claim 7, characterized in that after the step of carrying out second alignment of un-polymerized monomer without application of voltage if it is determined that un-polymerized monomer exists in the liquid crystal to have the monomer showing the pre-tilt angle, the method further comprises the following steps:
after the second alignment, subjecting the substrates to liquid crystal panel cutting to form a plurality of liquid crystal panels;
attaching polarizers to the plurality of liquid crystal panels and carrying out light-up test to further identify if any defect exists in the plurality of liquid crystal panels; and
carrying out laser cutting on the plurality of liquid crystal panels after it is identified that no defect exists in the plurality of liquid crystal panels in order to cut off edge lines of the liquid crystal panel.

9. The method as claimed in claim 8, characterized in that after the step of attaching polarizers to the plurality of liquid crystal panels and carrying out light-up test to further identify if any defect exists in the plurality of liquid crystal panels, the method further comprises the following step:
applying corresponding repairing processes to repair the liquid crystal panel when defects of weak lines and abnormal images are identified.

10. The method as claimed in claim 5 or 6, characterized in that the step of applying first alignment to have monomers of the liquid crystal polymerized to form pre-tilt angle after the inspection or after the repair comprises the following step:
after the inspection or after the repair, applying heating or ultraviolet radiation to subject the liquid crystal to the first alignment so that the monomers of the liquid crystal are polymerized to show the pre-tilt angle.

11. The method as claimed in claim 5, characterized in that before the step of after introducing liquid crystal between two substrates, subjecting the substrates to edge cutting in order to expose a signal pad, the method further comprises the following steps:
forming alignment layers on the two substrates; and
introducing the liquid crystal between the two substrates after the formation of the alignment layer, wherein the alignment layers are located on opposing surfaces of the two substrates.

12. A device for manufacturing liquid crystal panel, characterized by comprising:
an edge cutting mechanism for subjecting substrates to edge cutting in order to expose a signal pad after introducing liquid crystal between two substrates;
an inspection mechanism for supplying an inspection signal to the signal pad to effect inspection;
a repair mechanism for carrying out repair of defect when the inspection mechanism identifies a defect; and
a first alignment mechanism for applying first alignment to the substrates that have been inspected or repaired to have monomers of the liquid crystal polymerized to form pre-tilt angle.

13. The device as claimed in claim 12, characterized by further comprising:
an optic inspection mechanism for carrying out optic inspection on the liquid crystal after the first alignment in order to determine if any un-polymerized monomer exists in the liquid crystal; and
a second alignment mechanism for carrying out second alignment of un-polymerized monomer without application of voltage if it is determined that un-polymerized monomer exists in the liquid crystal to have the monomer showing the pre-tilt angle.

14. The device as claimed in claim 13, characterized by further comprising:
a chip cutting mechanism for subjecting the substrates that are determined to comprise no un-polymerized monomer or comprise un-polymerized monomer that is subjected to the second alignment to liquid crystal panel cutting to form a plurality of liquid crystal panels;
an attaching mechanism for attaching polarizers to the plurality of liquid crystal panels;
a test mechanism for carrying out light-up test on the plurality of liquid crystal panels to which the polarizers are attached to further identify if any defect exists in the plurality of liquid crystal panels; and
a laser cutting mechanism for carrying out laser cutting to cut off edge lines of the liquid crystal panels after it is identified that no defect exists in the plurality of liquid crystal panels with the light-up test.
